(19) United States
(12) Patent Application Publication
(10) Pub. No.: US 2025/0347464 A1
(43) Pub. Date: Nov. 13, 2025

(54) TREATMENT FACILITY AND METHOD FOR TREATING WORKPIECES AND/OR MATERIAL WEBS

(71) Applicant: DÜRR Systems AG, Bietigheim-Bissingen (DE)

(72) Inventors: Björn Beeh, Ludwigsburg (DE); Houver Chabo, Heilbronn (DE); Heiko Dieter, Besigheim (DE)

(21) Appl. No.: 18/867,907

(22) PCT Filed: May 23, 2023
(86) PCT No.: PCT/DE2023/100379

§ 371 Date: Nov. 21, 2024

(30) Foreign Application Priority Data
May 24, 2022 (DE) 10 2022 113 075.4

(51) Int. Cl. F26B 25/00; F26B 15/12; F26B 21/02; F26B 21/04; F26B 23/02; F26B 23/04

(52) U.S. Cl. CPC F26B 25/006; F26B 15/12; F26B 21/028; F26B 21/04; F26B 23/022; F26B 23/04; F26B 2210/12

(57) ABSTRACT

The present invention relates to a treatment facility (100) for treating workpieces and/or material webs (166), in particular to a drying facility (102) for vehicle bodies and/or battery electrode webs (168), comprising:
a treatment space (106), which comprises a plurality of treatment space portions (108), which are each assigned to one of a plurality of separate recirculated air modules (110) of the treatment facility (100),
a heat storage and heating facility (114) for storing and providing heat,
at least one heating gas guide system (116), which comprises at least one heating gas feed (118) and at least one heating gas return (120).

The present invention relates further to a method for treating workpieces and/or material webs (166), comprising:
causing a plurality of gas streams, guided in separate circuits, to flow through a plurality of treatment space portions (108) of a treatment space (106) of a treatment facility (100); directly or indirectly heating the gas streams by means of a heating gas stream generated in a heat storage and heating facility (114) of the treatment facility (100).

### RELATED APPLICATION

This application is a national phase of international application No. PCT/DE2023/100379 filed on May 23, 2023, and claims the benefit of German application No. 10 2022 113 075.4 filed on May 24, 2022, which are incorporated herein by reference in their entirety and for all purposes.

### FIELD OF DISCLOSURE

The disclosure relates to a treatment facility for workpieces and/or material webs, in particular to a drying facility for vehicle bodies and/or battery electrode webs. The present disclosure relates further to a method for treating such workpieces and/or such material webs.

### BACKGROUND

At present there are a plurality of methods for providing the necessary heat energy in a treatment facility, in particular a drying facility.

In the case of facilities without exhaust gas aftertreatment, in particular without thermal exhaust gas cleaning (TAR), the drying facility itself must be supplied with heat energy, for which purpose gas combustion chambers in the recirculated air units or modules are generally used. The fresh air supplied to the drying facility must in this case be heated separately.

By contrast, the heat energy from the cleaned exhaust gas of a facility with TAR can be used to heat the fresh air necessary for the drying facility via heat exchangers.

In particular in the field of coating within the context of lithium-ion battery manufacture and the drying processes associated therewith, the necessary supply of heat energy can be effected by means of a small combustion chamber and indirect heating of the circulating air. Indirect heating by means of steam or thermal oil heat exchangers are further possibilities for providing heat. Direct heating of the corresponding portions or zones of a treatment facility by means of electric air heaters is likewise possible.

Electrification of the heating process on the basis of renewable energy sources additionally represents a possibility for reducing the CO₂ footprint of a paint shop or of a coating facility for battery electrodes for lithium-ion batteries significantly, i.e. by about 40%. In the case of a drying facility of a paint shop, the CO₂ footprint could even be reduced by almost 100% if the gas used hitherto was replaced completely by electrical energy from renewable energy sources.

However, electrification of the corresponding drying facility in the paint shop or the battery electrode coating causes a considerably increased requirement for installed electrical power. As a result, the network connection power of such a paint shop or battery electrode coating facility at the electricity network increases considerably, which has a corresponding impact on the charges for the network connection. Furthermore, additional costs are incurred for the electrical infrastructure, such as, for example, for transformer stations, cabling, the required control engineering, etc.

In practice, two strategies are known for coping with the challenge of an increased requirement for electric power.

The first strategy concerns the management of peak current consumption inter alia in electrical drying facilities. Peak current consumption, i.e. a temporary maximum consumption, occurs for example as a result of the drying facility as a whole requiring short heating times in order to rapidly reach its operational state. This results in an increase in the necessary installed power of the drying facility and, consequently, in the necessary network connection power and, associated therewith, also in the fixed cost factor of the operation. In addition, high electricity consumption is always recorded when the utilization of the drying facility is not constant during operation as a result of production fluctuations, idle times, etc. For example, in partial-load operation, consumption is restricted for economic considerations alone. In this state, the drying facility is generally maintained at operating temperature. A load increase consequently occurs when production is increased, i.e. on transition to full-load operation. Consequently, consumption must temporarily be increased considerably in order to reach the necessary level of the facility, but in this case the previously determined operating point is approached at the maximum and the facility is not ramped up to the peak load, as is required for example in start-up operation.

It is known that, when the facility is being heated up, large amounts of energy are required for a short time, which in the case of purely electric heating of a treatment facility or drying facility requires high connection powers of the electric heating elements. In order for example to bring a drying facility to the desired operating temperature for the start of production within one to two hours, powers in the single-digit megawatt range are required for each facility. However, the production operation itself can likewise require powers in the single-digit megawatt range, and for this reason the immense requirement when starting up in a short time may be more easily understood, instead of as an absolute value, if it is borne in mind that the necessary installed power of such a start-up operation requires from one and a half times up to a maximum of three times the power of production operation. The facilities thus have to be overdimensioned in order to manage peak load phases.

If energy in the form of heat is buffered using a thermal storage system, peak consumption can be lowered by releasing or supplying heat in phases with an increased heat requirement, while heat is stored in phases with a low heat load. Dimensioning of the store is effected on the basis of the underlying operating strategies and boundary conditions, such as start-up times, operating hours per day or week (in particular in view of use of the facility in multi-shift operation), idle times, average utilization of the drying facility, etc.

The question of the economy of a heat store, or the implementation thereof, is driven in the case of this strategy inter alia by possible savings in terms of network charges and investments, such as for example on the basis of the required heating power, cabling, the transformer capacities, etc., and the additional capital costs for the suitable heat store.

The second strategy is concerned with increasing flexibility in respect of electricity procurement, also called “smart sourcing”, wherein it is to be understood that the first and second strategies are not or should not be applied strictly separately from one another but can intermesh with and supplement one another in order to permit optimal consumption of electrical energy.

The expansion of renewable energies ultimately led to greatly fluctuating energy production, which was also reflected inter alia in the evolution of electricity prices over the course of the day. The further addition of renewable energies and the discontinuation of schedulable production capacities will initially enhance this trend further. This offers the possibility, or makes it necessary, to achieve considerable cost advantages during operation by clever timing of electricity procurement.

The aim of the second strategy is not primarily to reduce the network connection power but to use times in which electricity prices are low, for example because of high, potentially excess electricity production or low demand, to store heat energy.

Such storage concepts result in advantages not only for the operator of the paint shop and the coating facility for battery electrodes. Electricity network operators also rely on cooperation with large industrial consumers, which are able to fill stores if required (from the point of view of the network operation), to stabilize the network and to balance production and consumption. To this end, financial incentives concerning the consumption prices and network connection fees are given, wherein the form and nature of mutual advantages can potentially be negotiable in a flexible manner.

Furthermore, the further addition of renewable energies will further increase the fluctuation of electricity production and thus also of the electricity exchange price in future. In fact, phases of negative electricity prices may/will also increase further, so that energy stores themselves may even generate revenue. In this respect, the size of the store and the number of storage cycles are the fundamental drivers for the generation of a positive return in this respect.

On the other hand, there are capital costs for the heat energy stores. The size of the heat store and the integrated heating power are therefore to be adjusted individually to the particular application. Ideally, heat stores are filled and emptied several times over the course of daily operation, but this is also dependent on the operating strategy for example of a paint shop or a battery electrode coating facility (number of shifts, idle times, etc.). A larger number of loading and unloading cycles increases the economy of the heat stores that are used.

### SUMMARY

Accordingly, examples disclosed herein are based on the object of providing a treatment facility, in particular a drying facility, for workpieces, in particular for vehicle bodies, of the type mentioned at the beginning, which stores and releases heat energy in order to reduce the power requirement, in particular the electrical power requirement, or at least extend and/or shift it in terms of time.

This object is achieved according to examples disclosed herein by the provision of a treatment facility for treating workpieces and/or material webs, in particular a drying facility for vehicle bodies and/or battery electrode webs, which comprises the following:
a treatment space, which comprises a plurality of treatment space portions, which are each assigned to one of a plurality of separate recirculated air modules of the treatment facility,
a heat storage and heating facility for storing and providing heat,
at least one heating gas guide system, which comprises at least one heating gas feed and at least one heating gas return.

Optionally, an exhaust air and/or exhaust gas treatment facility for treating, in particular for cleaning, at least part of the exhaust air and/or exhaust gas generated in the treatment space can additionally be provided, wherein the exhaust air and/or exhaust gas treatment facility is preferably an exhaust gas cleaning facility by means of which a) thermal and/or catalytic oxidative solvent conversion and/or b) solvent-separating cleaning can be carried out.

In a first alternative a), heating gas can be supplied via the heating gas feed from the heat storage and heating facility to the recirculated air modules and/or heating gas can be returned via the heating gas return from the treatment space portions to the heat storage and heating facility.

In this variant, the heat store is incorporated directly into the heating gas circuit between the recirculated air modules and the treatment space portions of the treatment facility. The heating gas is thus incorporated directly into the recirculated air circuit of the individual portions.

In a second alternative b), the treatment facility comprises a central heat exchanger for the atmospheric decoupling of the treatment space from the heat storage and heating facility, which heat exchanger is arranged between the heating gas feed connected to the recirculated air modules and the heating gas return connected to the treatment space portions and by means of which heat generated in the heat storage and heating facility can be transferred to the heating gas guided in the heating gas guide system.

In this variant, the heat store is incorporated as a heat source via a heat exchanger, which atmospherically separates from one another the store circuit of the heat storage and heating facility and the heating gas guide system of the treatment facility. Atmospheric separation permits high heat storage temperatures and thus a high energy density. In addition, possible contamination in the storage bed of the heat stores is ruled out, as are potential undesirable reactions of the returned solvent atmosphere. Furthermore, this variant in particular permits later refitting or retrofitting of the heat store in order to integrate possible newer storage technologies and/or additional capacities and/or adaptations.

In a third alternative c), each recirculated air module comprises a heat exchanger for the atmospheric decoupling of the respective treatment space portion from the heat storage and heating facility, by means of which heat exchanger heat generated in the heat storage and heating facility can be transferred to heating gases circulated in the treatment space portions.

In this variant, the heat store is connected directly to the treatment space by a pure heating gas guide system. The heat flow of the store is guided through conventional recirculated air modules each having its own heat exchanger. As a result, atmospheric separation of the heat flow of the heat storage and heating facility and the recirculated air streams between the recirculated air modules and the treatment space portions is likewise achieved. In contrast to a conventional drying facility heated by pure gas, the heat flow of the heat storage and heating facility is guided in a circuit, which requires a return to the heat storage and heating facility. Owing to its structural closeness to the conventional TAR structure of a drying facility, this variant is also seen as a possibility for equipping existing TAR drying facilities with a heat storage and heating facility according to examples disclosed herein.

It is optionally expedient in this variant to install a temperature control section between the hot gas feed and return, which facilitates exact adjustment of the heating gas temperature.

Cleaning of the exhaust gases or of the exhaust air of the treatment space portions of the treatment space is effected for example by regenerative thermal oxidation (RTO) in the thermal exhaust gas cleaning facility, preferably by flameless RTO (FRTO), which is likewise supplied with electricity, downstream of which there can further preferably be connected, in order to increase the efficiency of the system as a whole, a fresh air heat exchanger, which pre-heats the supplied fresh air.

Owing to the low temperature level of the exhaust air at the outlet of the RTO, it is advantageous in all variants to provide a further heat exchanger for heating fresh air, which transfers additional heat from the circuit of the heat storage and heating facility to the pre-heated fresh air.

It is further provided that the heat storage and heating facility comprises at least one electric heating device for heating a heating gas, at least one mixing device and at least one heat storage unit.

Intermediate buffering of the heat energy in the heat store, i.e. in the at least one heat storage unit, of the heat storage and heating facility is preferably effected by storing the heat during the weekend or during the breaks in production. The stored heat energy can thus be withdrawn in parallel with heat provided or generated by the electric heating device when the treatment facility has to be heated up to operating temperature or when more heat energy is required in the case of production peaks.

If the heat store comprises a plurality of heat storage units, it is advantageous for heat storage units to be able to be loaded with heat or unloaded individually.

The additional provision of heat energy from the heat store or the at least one heat storage unit advantageously allows more rapid heating rates to be achieved compared to a facility which has only an electric heating device. Furthermore, the installed power of the electric heating device, and thus the necessary connection power of the treatment facility, can be reduced as a result of the heat store. The heat storage and heating facility according to examples disclosed herein further makes it possible for the flexibility in electricity procurement to be increased, whereby electricity price fluctuations that are dependent on the time of day can be utilized.

It can additionally be provided that the mixing device is arranged downstream of the electric heating device.

The heating gas heated in the electric heating device can thus be directed, according to the operating mode of the heat storage and heating facility, at least in the direction toward the treatment space, in the direction toward the heat storage units or in the direction toward the treatment space, with admixture of the heat stored in the heat storage units.

In one embodiment of examples disclosed herein, it is provided that the mixing device is connected to the at least one heat storage unit.

It is advantageous if, via the mixing device arranged after, i.e. arranged downstream of, the electric heating device, heat energy can optionally be stored in the at least one heat storage unit.

In a further embodiment of examples disclosed herein, it is provided that the mixing device is adapted such that heating gas heated in the electric heating device
can be supplied to the treatment space, or
can be supplied to the at least one heat store for storage of at least part of the heat contained in the heating gas,
or can be supplied to the treatment space with admixture of at least part of the heat stored in the at least one heat store.

Accordingly, the mixing device advantageously has at least three switch positions via which the heating gas stream can preferably be guided.

It is further provided that a compressor is arranged upstream of the electric heating device.

By means of the compressor, which preferably comprises a motor-driven fan, the fresh air supplied to the heat storage and heating facility is supplied to the electric heating device in order then to heat it.

In a further embodiment of examples disclosed herein, it is provided that a further compressor is arranged downstream of the treatment space.

The further compressor, which likewise preferably comprises a motor-driven fan, conveys the gas stream returned from the treatment space back in the direction toward the electric heating device, where it is heated again.

In one embodiment of examples disclosed herein, it is provided that a controllable or adjustable valve is arranged downstream of the mixing device.

The gas stream guided to the treatment space can advantageously be controlled and/or adjusted via such a valve.

In a further embodiment of examples disclosed herein, it is provided that the treatment facility comprises a fresh air feed by means of which fresh air can be supplied to an admission lock and/or discharge lock of the treatment space.

Because the fresh air is supplied to the admission lock and/or discharge lock, vortices form at the admission lock and/or discharge lock of the treatment space and preferably prevent the heating gas circulated in the treatment space portions from leaving the treatment space, since it takes up solvent for example during the treatment, such as for example the drying of painted vehicle bodies.

In a further embodiment of examples disclosed herein, it is provided that the treatment facility comprises a fresh air heat exchanger by means of which heat generated in the exhaust air and/or exhaust gas treatment facility, in particular the thermal exhaust gas cleaning facility, can be transferred to the fresh air of the fresh air feed.

In a further embodiment of examples disclosed herein, it is provided that the treatment facility comprises a further fresh air heat exchanger by means of which heat generated in the heat storage and heating facility can be transferred to the fresh air of the fresh air feed.

By means of the two fresh air heat exchangers arranged in the flow path of the supplied fresh air, it is achieved that the fresh air is pre-heated or heated so that condensate does not form in the region of the admission lock and/or discharge lock, which represents a quality risk for the treated workpieces.

In a further embodiment of examples disclosed herein, it is provided that the treatment space portions are arranged one behind the other in a conveying direction of the workpieces.

Preferably, the workpieces are introduced into the treatment space via the admission lock and are then treated in the individual treatment space portions in accordance with the predetermined treatment, wherein it is conceivable that individual treatment space portions can also be omitted, i.e. the workpiece in question is simply conveyed through the corresponding treatment space portion if the treatment provided therein is not part of the overall treatment of the workpiece in question.

The treated workpiece preferably leaves the treatment space via the discharge lock.

In a further embodiment of examples disclosed herein, it is provided that the treatment facility comprises at least one aftertreatment space, which comprises at least one aftertreatment space portion to which cold gas, in particular fresh air, can be supplied.

Further heat is preferably not supplied to the aftertreatment space, which, based on the conveying direction of the treatment space, preferably adjoins the treatment space.

Supplied fresh air preferably flows through the aftertreatment space, in which in particular painted workpieces such as vehicle bodies are treated, in order successively to bring the treated workpieces to an ambient temperature.

It is further provided that the thermal exhaust gas cleaning facility comprises a gas burner and/or an electrically operated heating device and/or a gas turbine, in particular a micro gas turbine.

The object is further achieved according to examples disclosed herein by a method for treating workpieces and/or material webs, wherein the method comprises the following steps:
causing a plurality of gas streams, guided in separate circuits, to flow through a plurality of treatment space portions of a treatment space of a treatment facility; directly or indirectly heating the gas streams by means of a heating gas stream generated in a heat storage and heating facility of the treatment facility.

In one embodiment of the method according to examples disclosed herein, it is provided that heat from an electric heating device of the heat storage and heating facility or heat from the electric heating device and at least one heat storage unit of the heat storage and heating device is supplied to the heating gas stream.

It can be advantageous for the treatment facility, in particular one or more or all of the electrically operated heating devices and/or a processing device, to be able to be supplied with a mean voltage of at least approximately 3 KV and/or at most approximately 8 kV, in particular 4160 V to 6600 V.

Preferably, all the electrically operated heating components of the recirculated air facility or of the treatment facility, such as inter alia the preferably electrically operated heating devices, can be supplied with a mean voltage of for example at least approximately 3 KV and/or at most approximately 8 kV, in particular 4160 V to 6600 V, instead of the customary 400 V. This may indeed require special heating elements with corresponding additional costs, but preferably offers large saving potential in the periphery, i.e. with respect to the connections, cables, etc. Furthermore, a substantially lower factor of the voltage transformation from the supply network is required, this inter alia reducing the size of the transformer station to the benefit of lower capital costs and saving space. The connection to an electrically operated heating component with such a mean voltage also entails considerably lower cable diameters.

Further preferred features and/or advantages of examples disclosed herein are the subject of the description below and of the diagrammatic illustration of exemplary embodiments.

### BRIEF DESCRIPTION OF THE DRAWINGS

FIG. 1 shows a schematic illustration of a first embodiment of a treatment facility;

FIG. 2 shows a schematic illustration of a second embodiment of a treatment facility;

FIG. 3 shows a schematic illustration of a third embodiment of a treatment facility;

FIG. 4 shows a schematic illustration of normal operation of the heat storage and heating facility;

FIG. 5 shows a schematic illustration of the storage of heat energy in the heat storage units of the heat storage and heating facility;

FIG. 6 shows a schematic illustration of full-load operation of the heat storage and heating facility;

FIG. 7 shows a schematic illustration of a flushing procedure of the treatment facility;

FIG. 8 shows a schematic illustration of a first embodiment of a treatment facility for material webs with solvent recovery; and

FIG. 9 shows a schematic illustration of a second embodiment of a treatment facility for material webs with solvent recovery.

Identical or functionally equivalent elements are provided with the same reference signs in all of the figures.

### DETAILED DESCRIPTION OF THE DRAWINGS

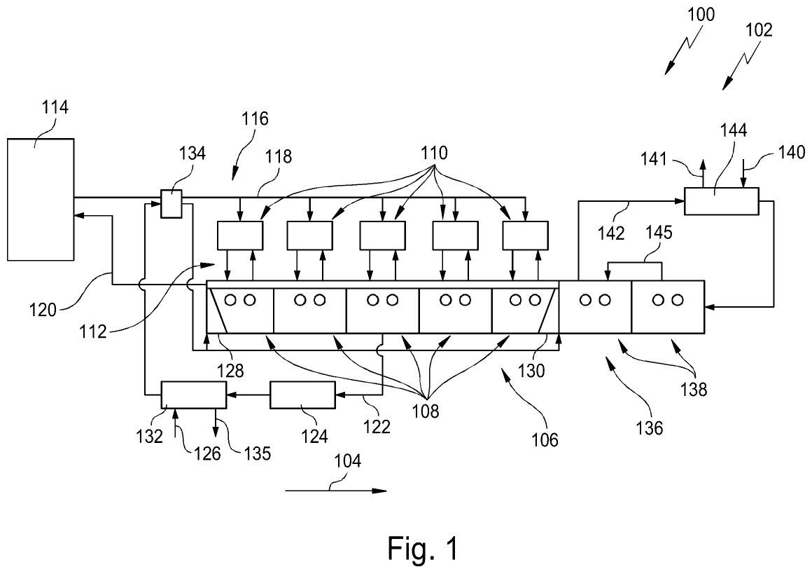

A first embodiment, illustrated schematically in FIG. 1, of a treatment facility denoted as a whole by 100 serves for the treatment of workpieces (not illustrated).

The treatment plant 100 is for example a drying plant 102 for drying workpieces.

The workpieces are for example vehicle bodies.

The treatment facility 100 preferably serves for the drying of previously painted or otherwise treated vehicle bodies.

The workpieces can preferably be conveyed by means of a conveying device (not illustrated) of the treatment facility 100 in a conveying direction 104 through a treatment space 106 of the treatment facility 100.

The treatment space 106 comprises a plurality of treatment space portions 108, for example at least three, preferably five, treatment space portions, or is formed by such treatment space portions 108.

A separate recirculated air module 110 is preferably assigned to each treatment space portion 108.

By means of each recirculated air module 110, a gas stream can preferably be guided in a circuit, in particular a recirculated air guide system 112, and can be guided through the respective treatment space portion 108. Preferably, a recirculated air module 110 and a treatment space portion 108 form a recirculated air guide system 112.

Preferably, each recirculated air module 110 comprises one or more fans for driving the gas stream guided in the circuit.

In particular, it can be provided that the gas stream guided in the recirculated air guide system 112 can be heated by the supply of heating gas. This heat input then in turn serves to heat the workpiece to be treated, in particular to dry a workpiece 102 in the form of a vehicle body.

The treatment facility 100 further comprises a heat storage and heating facility 114, which provides heating gas for heating the gas stream guided in the recirculated air guide system 112.

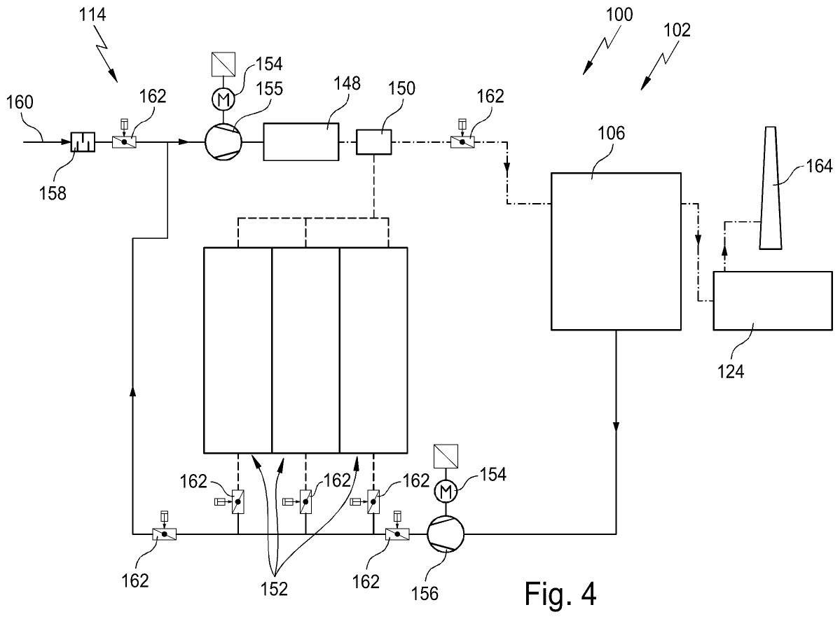

The structure and functioning of the heat storage and heating facility 114 will be described in greater detail below with reference to FIGS. 4 to 7.

In the first embodiment illustrated in FIG. 1, the treatment facility 100 comprises a heating gas guide system 116, which comprises a heating gas feed 118 and a heating gas return 120.

The heating gas feed 118 guides heating gas heated in the heat storage and heating facility 114 to the recirculated air modules 110.

At least part of the gas circulated in the treatment space portions 108 is returned via the heating gas return 120 to the heat storage and heating facility 114.

Part of the gas circulated in the treatment space portions 108, or of the gas guided in the circuit between the treatment space portions 108 and the recirculated air modules 110, is further preferably guided via an exhaust gas guide system 122 to a thermal exhaust gas cleaning facility 124 of the treatment facility 100.

In the thermal exhaust gas cleaning facility 124, the exhaust gases, which contain inter alia solvent, are burned for cleaning.

The exhaust gases cleaned in the thermal exhaust gas cleaning facility 124 are discharged in the form of exhaust air to the environment.

The treatment facility 100 further preferably comprises a fresh air feed 126, with which fresh air is guided to an admission lock 128 and a discharge lock 130 of the treatment space 106.

In the path of the fresh air feed 126 there are further preferably arranged a first fresh air heat exchanger 132 and a second fresh air heat exchanger 134, which transfer heat to the supplied fresh air, so that the formation of condensate in the admission lock 128 and/or the discharge lock 130 is avoided.

The second fresh air heat exchanger 134 preferably serves for the residual heating of the fresh air to the required process temperature in the treatment space portions 108, and for the compensation of temperature fluctuations, which are attributable to an electrically operated RTO system.

The first fresh air heat exchanger 132 is arranged between the fresh air feed 126 and the thermal exhaust gas cleaning facility 124 such that the heat contained in the exhaust air 135 of the thermal exhaust gas cleaning facility 124 is transferred to the supplied fresh air.

The second fresh air heat exchanger 134 is arranged in the heating gas feed 118 between the heat storage and heating facility 114 and the recirculated air modules 110 and transfers part of the heat of the heating gas guided in the heating gas feed 118 to the fresh air.

The treatment facility 100 preferably further comprises an aftertreatment space 136, which comprises at least one, in particular two, aftertreatment space portion(s) 138.

The aftertreatment space 136 is preferably arranged, based on the conveying direction 104, after the treatment space 106.

The aftertreatment space portions 138 are supplied with fresh air, or fresh air flows through them, via a further fresh air feed 140.

In the aftertreatment space portions 138, additional heat is preferably not supplied to the workpieces dried in the treatment space 106.

Nevertheless, during aftertreatment in the aftertreatment space portions 138, i.e. preferably on further drying, the workpieces release heat supplied in the treatment space 106.

The exhaust air 141 of the aftertreatment space 136 is guided via an exhaust air guide system 142 through a further, third fresh air heat exchanger 144 such that at least part of the heat contained in the exhaust air is transferred to the supplied fresh air of the fresh air feed 140.

The fresh air guided by the fresh air feed 140 to the aftertreatment space portions 138 is preferably further guided via at least one gas guide system 145 from one aftertreatment space portion 108 to the next.

The arrangement of the heating gas guide system of the first embodiment shown in FIG. 1 allows heating gas to be guided directly from the heat storage and heating facility 114 to the recirculated air module 110 and from the treatment space portions 108 directly back to the heat storage and heating facility 114.

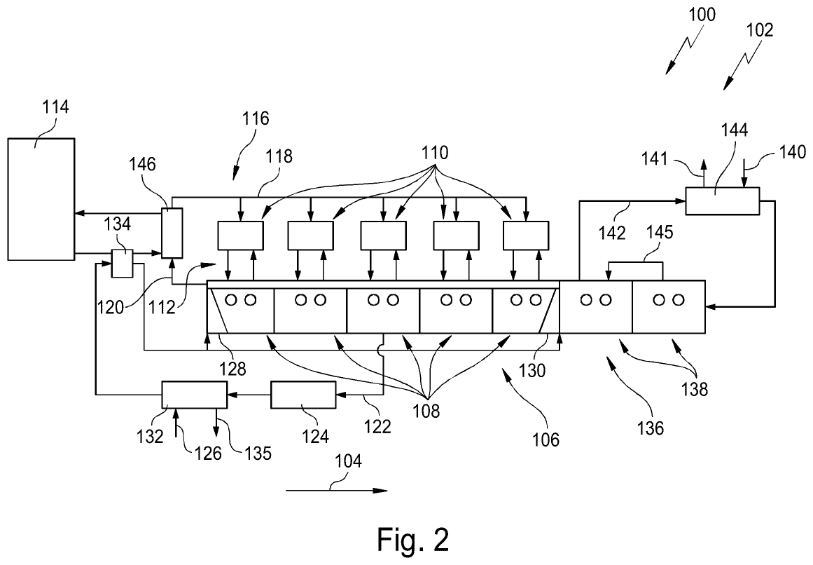

In the second embodiment, illustrated schematically in FIG. 2, of the treatment facility 100, heating of the heating gas guided in the heating gas feed 118 is effected indirectly via a central heat exchanger 146, which transfers the heat generated or provided in the heat storage and heating facility 114 to the heating gas guided in the heating gas feed 118 or in the heating gas return 120.

The gas stream of the heat storage and heating facility 114 is thus fluidically separated from the heating gas stream in the heating gas guide system 116.

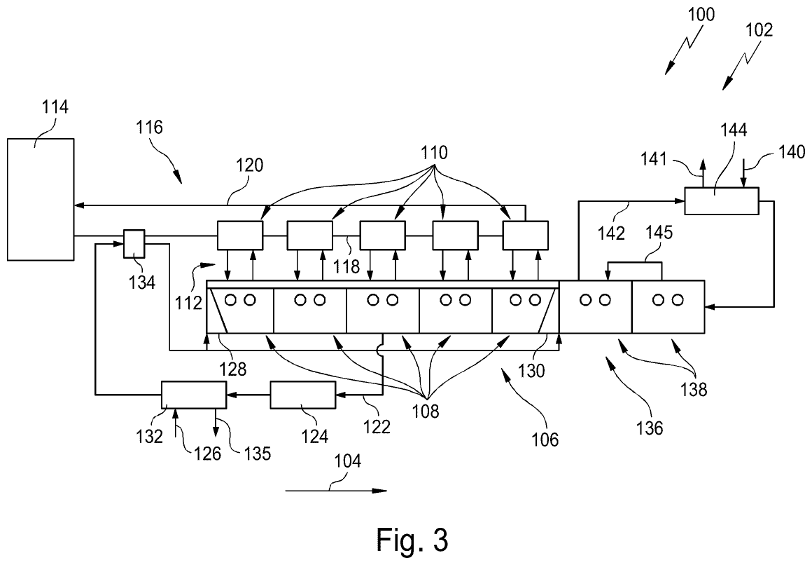

FIG. 3 illustrates schematically a third embodiment of the treatment facility 100, in which the recirculated air modules 110 each have their own heat exchanger (not illustrated), said heat exchangers being thermally coupled with the heating gas feed 118, i.e. heat of the heating gas guided in the heating gas feed 118 is transferred to the gas stream guided in the recirculated air guide system 112.

The heating gas guide system 116 of the third embodiment is thus atmospherically decoupled from the gas streams between the recirculated air modules 110 and the treatment space portions 108.

In particular, pure gas, i.e. gas without for example solvent inputs, is guided in the heating gas guide system 116 of the third embodiment.

In FIGS. 4 to 7, the treatment facility 100 is illustrated schematically such that the various operating modes or states of the heat storage and heating facility 114 are visible, wherein the solid connecting lines represent a gas guide system with cold gas or a cooled gas, while the dot-and-dash connections represent a gas guide system with heating gas. The dashed connections symbolize that no gas is guided through these connections in the operating mode in question.

FIG. 4 shows a schematic illustration of normal operation of the heat storage and heating facility 114.

The heat storage and heating facility 114 preferably comprises an electric heating device 148, a mixing device 150 and at least one, preferably three, heat storage units 152, which together form a heat store.

The heat storage and heating facility 114 further comprises preferably a first and a second fan compressor 155, 156 driven by a motor 154, said fan compressors conveying the gas stream in the heat storage and heating facility 114.

The heat storage and heating facility 114 further preferably comprises a sound damper unit 158, which reduces sound emission when fresh air 160 is being supplied into the heat storage and heating facility 114.

In addition, the heat storage and heating facility 114 comprises in particular at least one, preferably seven, controlled and/or adjusted valves 162 for controlling and/or adjusting the gas volume flow in the heat storage and heating facility 114.

In normal operation, fresh air 160 is supplied to the heat storage and heating facility 114, said fresh air first passing through the sound damper unit 158 in order to reduce sound emission.

Via a valve 162, which is arranged downstream of the sound damper 158 and is preferably piston-controlled and/or -adjusted, the volume flow of the fresh air feed is controlled and/or adjusted.

The supplied fresh air is conveyed by means of the first fan compressor 155 in the direction toward the electric heating device 148, in which the supplied fresh air is heated.

Downstream of the electric heating device 148 there is arranged the mixing device 150, which in normal operation directs the gas heated in the electric heating device 148, i.e. the heating gas, in accordance with its switch position.

The mixing device 150 preferably has at least three switch positions.

In the first switch state, the heating gas supplied by the electric heating device 148 is directed solely in the direction toward the treatment space 106 arranged downstream of the mixing device 150.

In the second switch state, the heating gas is directed solely in the direction toward the heat storage units 152 for storage of the heat energy.

And in the third switch state, the heating gas coming from the electric heating device 148 is directed, with admixture of the heat energy stored in the heat storage units 152, in the direction toward the treatment space 106.

In normal operation according to FIG. 4, the mixing device 150 in its first switch position directs the heating gas through a valve 162 arranged downstream in the direction toward the treatment space 106, wherein the valve 162 adjusts and/or controls the volume flow of the heating gas.

Thus, in so-called normal operation, no heating gas is directed into the heat storage units 152 for storage.

Part of the gas circulated in the treatment space 106 is directed into the thermal exhaust gas cleaning facility 124 and from there is guided out of the treatment facility 100 in the form of cleaned exhaust air via an exhaust air line 164.

Depending on the embodiment of the three embodiments of the treatment facility 100 according to examples disclosed herein that are illustrated in FIGS. 1 to 3, a further part of the gas used in the treatment space 106 is returned to the heat storage and heating facility 114.

With reference to the first embodiment illustrated in FIG. 1, cooled gas from the treatment space portions 108 is thus returned directly back to the heat storage and heating facility 114, while with reference to the second and third embodiments illustrated in FIGS. 2 and 3, cooled pure gas is returned.

The returned, cooled gas stream is then conveyed by means of the second fan compressor 156 in the direction toward the electric heating device 148 in order to be heated again.

Downstream of the second fan compressor 156 there are preferably arranged two controlled and/or adjusted valves 162, which control and/or adjust the volume flow in the direction toward the electric heating device 148.

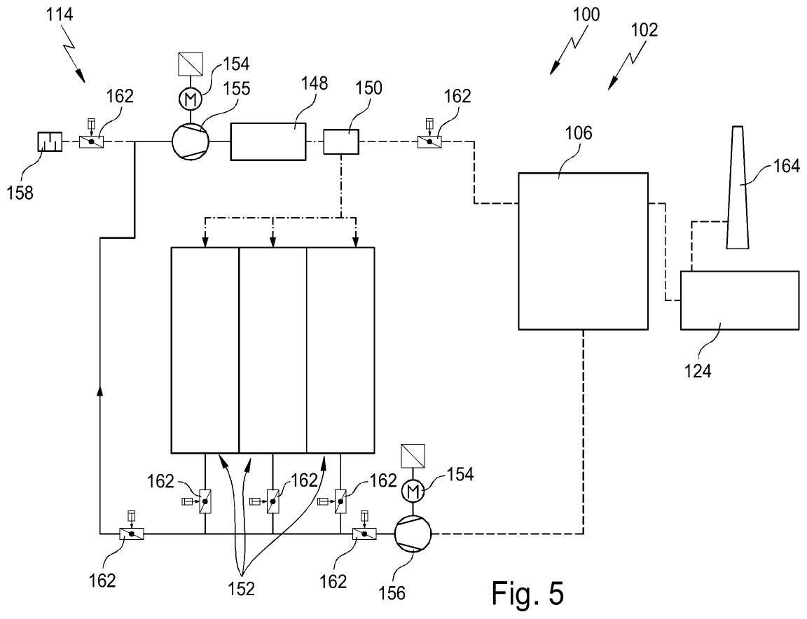

FIG. 5 shows a schematic illustration of the storage of heat energy in the heat storage units 152 of the heat storage and heating facility 114.

Parallel storage in all the comprised heat storage units 152 is illustrated. It is, however, also conceivable that heat energy is supplied only to one or only to some of the heat storage units 152, for which purpose additional valves can be provided between the mixing device 150 and the heat storage units 152.

During the storage operation, the valves 162 assigned to the heat storage unit 152 in question, which are arranged downstream of the heat storage units 152 in question, are at least partially open in order preferably to allow the residual gas displaced by the supplied heating gas, said residual gas being contained in the heat storage units 152 and preferably having a lower temperature than the supplied heating gas, to flow into the circuit of the heat storage and heating facility 114.

At the end of the storage of the heat energy, the valves 162 assigned to the heat storage units 152 are closed and the mixing device 150 is preferably switched into its first switch position.

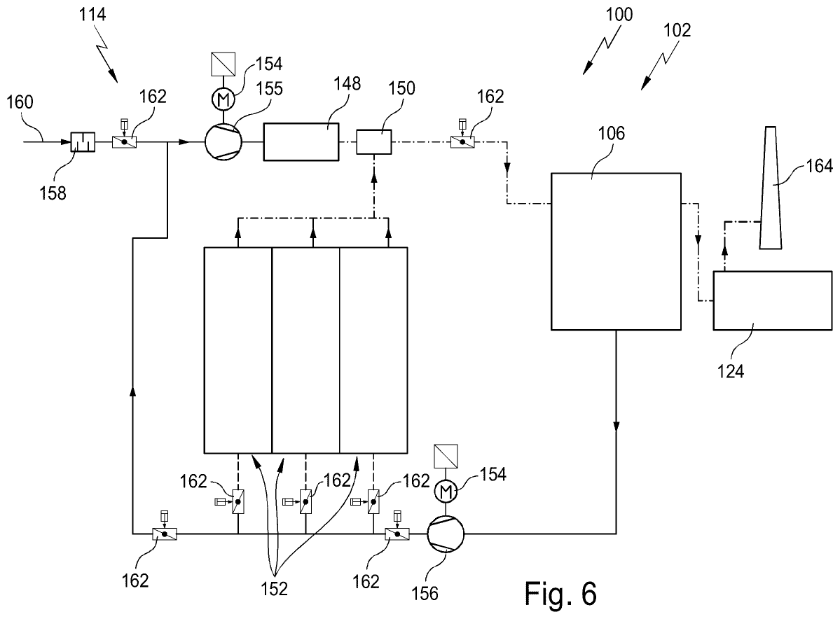

FIG. 6 shows a schematic illustration of full-load operation of the heat storage and heating facility 114.

In full-load operation, in which it is necessary to bring the treatment space 106 to the necessary operating temperature in a very short time, the mixing device 150 is switched into its third switch position in order to mix, preferably temporarily, heat energy of the heat stored in the heat storage units 152 with the heating gas heated in the electric heating device 148.

Preferably, as soon as the required operating temperature has been reached, the mixing device 150 switches back into its first switch position so that no further heat is released from the heat storage units 152.

In any downtimes or idle times, heat energy can then preferably again be stored in the heat storage units 152 in order to keep the heat energy available for full-load operation.

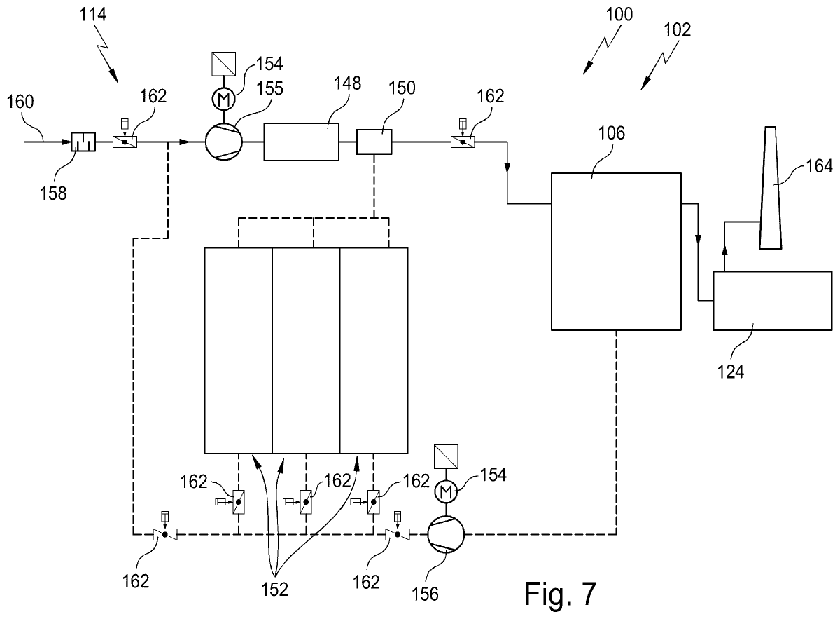

FIG. 7 shows a schematic illustration of a flushing procedure of the treatment facility 100.

During the flushing procedure, the electric heating device 148 does not carry out heating, so that the supplied fresh air 160 flows through the electric heating device 148, the mixing device 150 and also the treatment space 106 and the thermal exhaust gas cleaning facility 124 in order to flush the corresponding gas guide system.

It is further conceivable that the heat storage units 152 can also be flushed if required by switching the mixing device 150.

In particular, it is further to be possible for the flushing gas to be burned in the thermal exhaust gas cleaning facility 124 in order that it is cleaned before being guided out of the treatment facility via the exhaust air line 164.

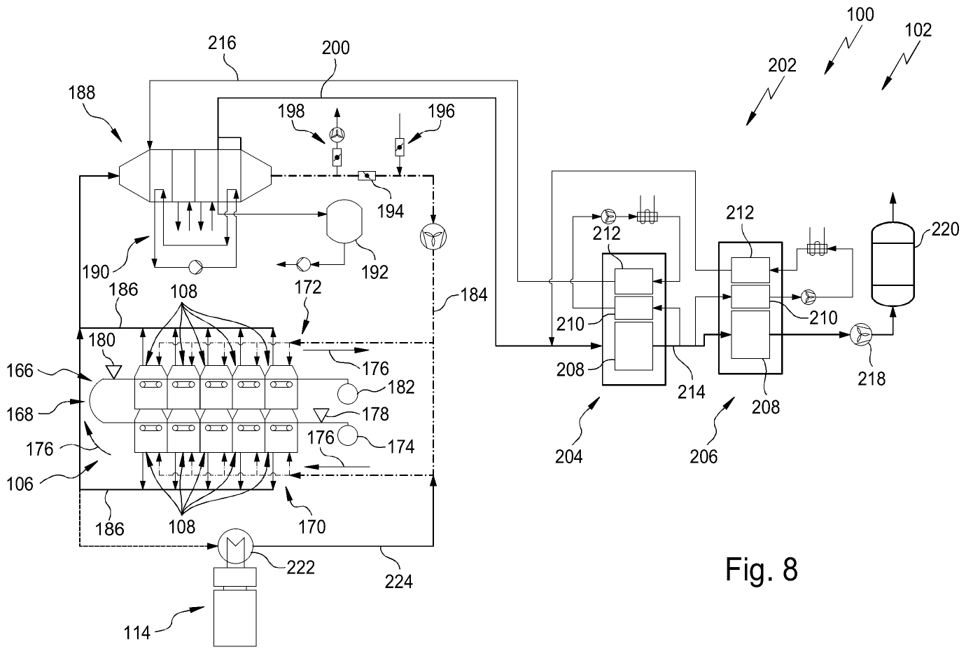

FIG. 8 shows a schematic illustration of a first embodiment of a treatment facility 100, in particular a drying facility 102, for treating material webs 166, in particular battery electrode webs 168 for the production of lithium-ion batteries.

The treatment facility 100 likewise has a treatment space 106, which comprises a plurality of treatment space portions 108, wherein the portions 108 are divided into a first group 170 and a second group 172.

The embodiment illustrated in FIG. 8 shows so-called tandem coating, in which the material web 166 is first unwound from a first roll 174 and conveyed in a conveying direction 176.

By means of a first coating device 178, preferably a slot die, the material web 166 is coated on one side and then guided through a first group 170 of treatment space portions 108, wherein the coating of the material web 166 is dried in the first group 170 of treatment space portions.

Downstream of the first group 170, the material web 166 is deflected such that a second coating device 180, preferably a slot die, is able to coat the other side of the material web 166.

Following the second coating operation, the material web 166 is guided through the second group 172 of coating space portions 108, so that the coating on the other side of the material web 166 is also dried.

Finally, the material web 166 coated on both sides is wound onto a second roll 182.

Winding on the second roll 182 can preferably be preceded by a method step of calendering.

Also conceivable is an arrangement of the treatment space 106 and of the first and second coating devices 178, 180 such that all the treatment space portions 108 are arranged one behind the other in the conveying direction 176 and the coating devices 178, 180 are arranged upstream of the treatment space 106 such that both sides of the material web 166 can be coated at the same time.

For drying, a recirculated air stream is supplied to the treatment space portions 108 via a recirculated air feed 184.

While the solvent-containing exhaust air is discharged from the treatment space portions 108 via an exhaust air guide system 186.

In the course of the electrode coating, an electrode material comprising a lithium compound, a binder and a solvent is applied to the material web 166, wherein the solvent is for example N-methyl-2-pyrrolidone (NMP). As a result of the coating and drying operation, NMP is present in gaseous form and is contained in the recirculated air in the treatment space portions 108.

Part of the discharged exhaust air is supplied to a solvent recovery device 188, in which a heat recovery device 190 is integrated.

In the solvent recovery device 188, the solvent-containing exhaust air is cooled down in one or more stages and the condensed NMP is collected in a container 192.

The condensed NMP can subsequently for example be worked up and kept available in a storage container for further coating operations.

Part of the solvent-reduced air that is available at the end of the solvent recovery device 188 is supplied via the recirculated air feed 184 to the treatment space portions 108 again, wherein the supply or the volume flow is adjustable via adjustment of the quantity of air to the exhaust air cleaning facility 202.

Fresh air can additionally be added to the recirculated air feed via an adjustable fresh air feed 196. Flushing of all the treatment space portions 108 for example is thus possible.

An adjustable emergency suction system 198 can further be provided at the recirculated air feed in order to discharge recirculated air from the recirculated air feed 184 if required.

Preferably, in the region of the last stage of the solvent recovery facility 188, a further part of the solvent-reduced air from the solvent recovery device 188 is further supplied via a bypass guide system 200 to an exhaust gas cleaning facility 202 having a first cleaning stage 204 and a possible second cleaning stage 206. The bypass guide system is in particular a side stream guide system. One or more cleaning stages comprise in particular a one- or two-stage concentration, wherein an activated charcoal filter can optionally be provided for further cleaning.

Each of the two cleaning stages 204, 206 comprises an adsorption region 208, a cooling region 210 and a desorption region 212.

The air 214 adsorbed in the first cleaning stage 204 in the associated adsorption region 208 is on the one hand supplied to the cooling regions 210 of the first and second cleaning stages 204, 206 and, from there, in each case to the desorption regions 212.

On the other hand, this adsorbed air 214 is supplied to the adsorption region 208 of the second cleaning stage 206, flows through this region and is supplied via a fan 218 to an air filter device 220, from where the air, in filtered form, is discharged to the atmosphere.

The air flowing through the desorption region 212 of the first cleaning stage 204 is returned in the form of concentrated air 216 to the solvent recovery device 188, where it is mixed with the solvent-containing exhaust air of the treatment space 106.

The air flowing through the desorption region 212 of the second cleaning stage 206, on the other hand, is directed to the bypass guide system 200 and thus flows through the exhaust gas cleaning facility 202 again.

In the case of a one-stage exhaust gas cleaning facility 202, the single cleaning stage preferably corresponds functionally and structurally to the first cleaning stage 204.

The exhaust air guide system 186, which supplies part of the recirculated air discharged from the treatment space portions 108 to the solvent recovery device 188, is branched downstream of the treatment space 106 such that the other part is supplied to a central heat exchanger 222, via which heat energy of a heat storage and heating facility 114 as described above is transferred to the exhaust air.

The heated exhaust air is directed via a heating gas feed 224 into the recirculated air guide system 184 and thus mixed with the recirculated air for the treatment space portions 108.

Thus, the heat storage and heating facility 114 can also be used within the context of a drying facility 102 for battery electrode webs 168 in order to provide sufficient heat energy for the drying operation in the treatment space 106.

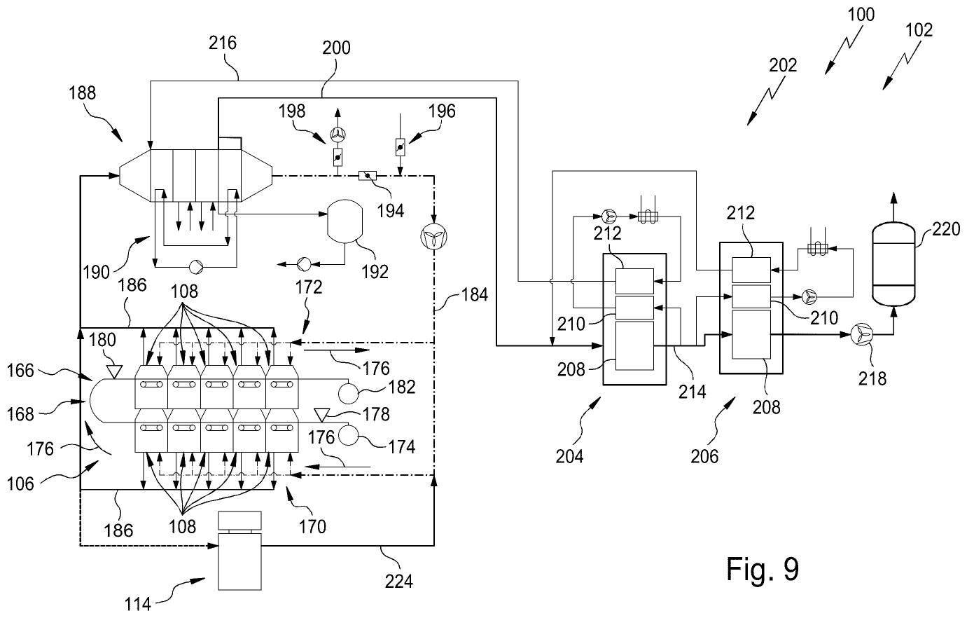

FIG. 9 illustrates a second embodiment of a treatment facility 100 for material webs 166, which differs from the first embodiment illustrated in FIG. 8 in that there is no central heat exchanger for atmospheric decoupling upstream of the heat storage and heating facility 114 but instead the exhaust air discharged from the treatment space portions 108 is guided directly into the heat storage and heating facility 114, where it is heated and/or stored or released.

### LIST OF REFERENCE SIGNS

100 Treatment facility
102 Drying facility
104 Conveying direction
106 Treatment space
108 Treatment space portions
110 Recirculated air module
112 Recirculated air guide system
114 Heat storage and heating facility
116 Heating gas guide system
118 Heating gas feed
120 Heating gas return
122 Exhaust gas guide system
124 Thermal exhaust gas cleaning facility
126 Fresh air feed
128 Admission lock
130 Discharge lock
132 First fresh air heat exchanger
134 Second fresh air heat exchanger
135 Exhaust air
136 Aftertreatment space
138 Aftertreatment space portions
140 Fresh air feed of the aftertreatment space
141 Exhaust air of the aftertreatment space
142 Exhaust air guide system
144 Third fresh air heat exchanger
146 Central heat exchanger
148 Electric heating device
150 Mixing device
152 Heat storage unit
154 Motor for fan compressor
155 First fan compressor
156 Second fan compressor
158 Sound damper unit
160 Fresh air
162 Controlled and/or adjusted valve
164 Exhaust air line
166 Material web
168 Battery electrode web
170 First group of treatment space portions
172 Second group of treatment space portions
174 First roll
176 Conveying direction
178 First coating device
180 Second coating device
182 Second roll
184 Recirculated air feed
186 Exhaust air guide system
188 Solvent recovery device
190 Heat recovery device
192 Container
194 Throttle
196 Fresh air feed
198 Emergency suction system
200 Bypass guide system
202 Exhaust gas cleaning facility
204 First cleaning stage
206 Second cleaning stage
208 Adsorption region
210 Cooling region
212 Desorption region
214 Adsorbed air
216 Concentrated air
218 Fan
220 Air filter device
222 Central heat exchanger
224 Heating gas feed

1. A treatment facility for treating workpieces and/or material webs, optionally a drying facility for vehicle bodies and/or battery electrode webs, the treatment facility comprising:
a treatment space, which includes a plurality of treatment space portions, which are each assigned to one of a plurality of separate recirculated air modules of the treatment facility,
a heat storage and heating facility for storing and providing heat, and
at least one heating gas guide system, which comprises includes at least one heating gas feed and at least one heating gas return,
wherein
a) heating gas can be supplied via the heating gas feed from the heat storage and heating facility to the recirculated air modules and/or heating gas can be returned via the heating gas return from the treatment space portions to the heat storage and heating facility, or
b) the treatment facility includes a central heat exchanger for the atmospheric decoupling of the treatment space from the heat storage and heating facility, which heat exchanger is arranged between the heating gas feed connected to the recirculated air modules and the heating gas return connected to the treatment space portions and by which heat generated in the heat storage and heating facility can be transferred to the heating gas guided in the heating gas guide system, or
c) each recirculated air module includes a heat exchanger for the atmospheric decoupling of the respective treatment space portion from the heat storage and heating facility, by which heat exchanger heat generated in the heat storage and heating facility can be transferred to heating gases circulated in the treatment space portions.

2. The treatment facility as claimed in claim 1, wherein the heat storage and heating facility includes at least one electric heating device for heating a heating gas, at least one mixing device and at least one heat storage unit.

3. The treatment facility as claimed in claim 2, wherein the mixing device is arranged downstream of the electric heating device.

4. The treatment facility as claimed in claim 2, wherein the mixing device is connected to the at least one heat storage unit.

5. The treatment facility as claimed in claim 2, wherein the mixing device is adapted such that heating gas heated in the electric heating device
can be supplied to the treatment space, or
can be supplied to the at least one heat store for storage of at least part of the heat contained in the heating gas, or
can be supplied to the treatment space with admixture of at least part of the heat stored in the at least one heat store.

6. The treatment facility as claimed in claim 2, wherein a compressor is arranged upstream of the electric heating device.

7. The treatment facility as claimed in claim 6, wherein a further compressor is arranged downstream of the treatment space.

8. The treatment facility as claimed in claim 2 wherein a controllable or adjustable valve is arranged downstream of the mixing device.

9. The treatment facility as claimed in claim 1, wherein the treatment facility includes a fresh air feed by of which fresh air can be supplied to an admission lock and/or discharge lock of the treatment space.

10. The treatment facility as claimed in claim 9, wherein the treatment facility includes a fresh air heat exchanger by which heat generated in an exhaust air and/or exhaust gas treatment facility, optionally a thermal exhaust gas cleaning facility, of the treatment facility can be transferred to the fresh air of the fresh air feed.

11. The treatment facility as claimed in claim 10, wherein the treatment facility includes a further fresh air heat exchanger by which heat generated in the heat storage and heating facility can be transferred to the fresh air of the fresh air feed.

12. The treatment facility as claimed in claim 1, wherein the treatment space portions are arranged one behind the other in a conveying direction of the workpieces.

13. The treatment facility as claimed in claim 1, wherein the treatment facility comprises includes at least one aftertreatment space, which comprises includes at least one aftertreatment space portion to which cold gas, in particular fresh air, can be supplied.

14. The treatment facility as claimed in claim 1, wherein there is an exhaust air and/or exhaust gas treatment facility for treating, optionally for cleaning, at least part of the exhaust air and/or exhaust gas generated in the treatment space, wherein the exhaust air and/or exhaust gas treatment facility is preferably an exhaust gas cleaning facility by which
a) thermal and/or catalytic oxidative solvent conversion and/or
b) solvent-separating cleaning can be carried out.

15. The treatment facility as claimed in claim 14, wherein the exhaust air and/or exhaust gas treatment facility is a thermal exhaust gas cleaning facility, which includes optionally a gas burner and/or a gas turbine, optionally a micro gas turbine.

16. A method for treating workpieces and/or material webs, the method comprising:
causing a plurality of gas streams, guided in separate circuits, to flow through a plurality of treatment space portions of a treatment space of a treatment facility; and
directly or indirectly heating the gas streams by a heating gas stream generated in a heat storage and heating facility of the treatment facility.

17. The method as claimed in claim 16, wherein heat from an electric heating device of the heat storage and heating facility or heat from the electric heating device and at least one heat storage unit of the heat storage and heating device is supplied to the heating gas stream.

18. The method as claimed in claim 17, wherein heat generated by the electric heating device of the heat storage and heating facility is stored in the at least one heat storage unit of the heat storage and heating facility at times of low electricity prices.

19. The method as claimed in claim 17, wherein heat stored by the at least one heat storage unit of the heat storage and heating facility is released and supplied to the heating gas stream at times of high electricity prices.

20. The method as claimed in claim 17, wherein, in phases with an increased heat requirement in the treatment space of the treatment facility, heat stored in the at least one heat storage unit of the heat storage and heating facility is released and supplied to the heating gas stream.

21. The method as claimed in claim 17, wherein, in phases with a low energy requirement in the treatment space of the treatment facility, heat generated by the electric heating device of the heat storage and heating facility is stored in the at least one heat storage unit of the heat storage and heating facility.
